(19) United States
(12) Patent Application Publication
(10) Pub. No.: US 2017/0008251 A1
(43) Pub. Date: Jan. 12, 2017

(54) HIGH PERFORMANCE PLASTIC RADOME

(71) Applicant: Raytheon Company, Waltham, MA (US)

(72) Inventors: James A. Pruett, Allen, TX (US); Travis Mayberry, Lewisville, TX (US); Kuang-Yuh Wu, Plano, TX (US); Gray E. Fowler, Allen, TX (US)

(21) Appl. No.: 14/794,312

(22) Filed: Jul. 8, 2015

(51) Int. Cl. B32B 5/18; B32B 37/14; B32B 27/32; B32B 27/08; B32B 7/12

(52) U.S. Cl. CPC B32B 5/18; B32B 27/08; B32B 7/12; B32B 27/32; B32B 37/14; B32B 2250/242; B32B 2255/102; B32B 2266/025; B32B 2307/72; B32B 2571/00

(57) ABSTRACT

A radome is provided and includes a first layer of low density polymer (LDPE) through which electromagnetic radiation is transmittable, a second layer of LDPE foam through which the electromagnetic radiation, having passed through the first layer, is transmittable, a third layer of LDPE through which the electromagnetic radiation, having passed through the first and second layers, is transmittable and adhesive layers respectively interposed between the first and second layers and between the second and third layers.

### BACKGROUND

The present invention relates to a high performance plastic radome and, more specifically, to a high performance plastic radome with layers of low density polymer LDPE and LDPE foam.

A large number of radar systems require a radome to provide environmental protection to the electronic apertures. Such radomes are sometimes designed and optimized to have high performance characteristics in that they provide for minimum radio frequency (RF) loss, are ruggedized for environmental protection and are relatively light weight with little regard to low cost. These radomes can be designed for commercial and/or military applications and can be optimized for different frequency bands of the electromagnetic spectrum. In addition, radomes sometimes need to be resistant to and sealed against moisture, chemicals, gases and dust, plus be able to withstand wide temperature ranges and have a required color. It is often needed that designers sacrifice low cost to meet all these other requirements.

High performance radomes require careful selection and understanding of material properties that directly affect radome and antenna performance. The combination of high performance requirements and a requirement for low cost create a problem where a solution is not intuitively obvious. For instance, conventional A-sandwich and C-sandwich radome constructions are common ways to have low RF loss, low weight and high strength but are not considered low cost designs. An A-sandwich radome has two high dielectric skins (sheets) and a low dielectric core, whereas a C-sandwich radome has three high dielectric skins and two low dielectric cores. A conventional A-sandwich or C-sandwich radome construction utilizes specialty materials, requires a cure cycle, and is usually an autoclave operation. They are typically designed with multiple types of materials and uncommon thicknesses of materials, using a radome facility with an autoclave and highly trained personnel for assembly.

### SUMMARY

According to one embodiment of the present invention, a radome is provided and includes a first layer of low density polymer (LDPE) through which electromagnetic radiation is transmittable, a second layer of LDPE foam through which the electromagnetic radiation, having passed through the first layer, is transmittable, a third layer of LDPE through which the electromagnetic radiation, having passed through the first and second layers, is transmittable and adhesive layers respectively interposed between the first and second layers and between the second and third layers.

According to another embodiment of the present invention, a radome is provided and includes a first layer of low density polymer (LDPE) foam through which electromagnetic radiation is transmittable, a second layer of LDPE through which the electromagnetic radiation, having passed through the first layer, is transmittable, a third layer of LDPE through which the electromagnetic radiation, having passed through the first and second layers, is transmittable, a fourth layer of LDPE foam through which the electromagnetic radiation, having passed through the first, second and third layers, is transmittable, a fifth layer of LDPE through which the electromagnetic radiation, having passed through the first, second, third and fourth layers, is transmittable and adhesive layers respectively interleaved between the first, second, third, fourth and fifth layers.

According to another embodiment of the present invention, a method of forming a radome is provided and includes rotomolding two or more layers of low density polymer (LDPE), rotomolding one or more layers of LDPE foam and adhering the two or more layers of LDPE and the one or more layers of LDPE foam.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1A is a side schematic illustration of a radome in accordance with embodiments;

FIG. 1B is an enlarged side schematic illustration of a portion of a radome in accordance with embodiments;

FIG. 2 is a side schematic illustration of a radome in accordance with further embodiments;

FIG. 3 is a side schematic illustration of a radome in accordance with further embodiments;

FIG. 4 is a side schematic illustration of a radome in accordance with further alternative embodiments;

FIG. 5 is a side schematic illustration of a radome in accordance with further alternative embodiments;

FIG. 6 is a perspective view of a planar radome and housing in accordance with embodiments; and

FIG. 7 is a top down view of a complex-shaped radome in accordance with embodiments.

### DETAILED DESCRIPTION

As will be described below, a radome is provided that includes low cost materials and requires low cost processes to construct A-sandwich configurations, C-sandwich configurations and modified versions of both to achieve high performance at very low cost. The achievable high performance includes low RF loss, ruggedizaton for environmental protection and low weight. The low cost materials include polyolefins, polyethylene and polypropylene with off-the-shelf color and thicknesses. The low cost processes employ pressure sensitive adhesive (PSA) between higher dielectric sheets and lower dielectric foam. Complex shapes are addressed by rotomolding. The assembly of the radomes does not require a cure cycle or an autoclave and does not require highly trained personnel.

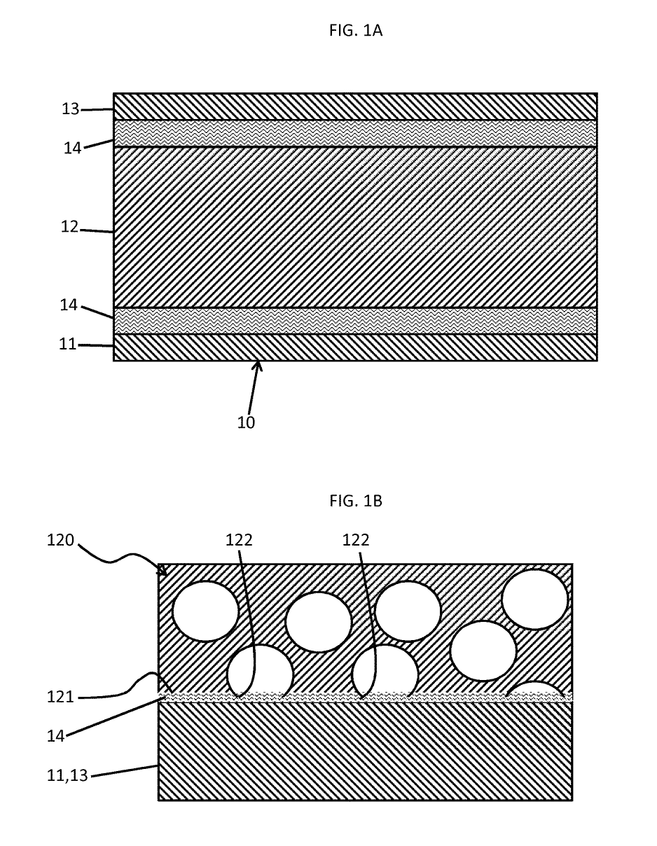

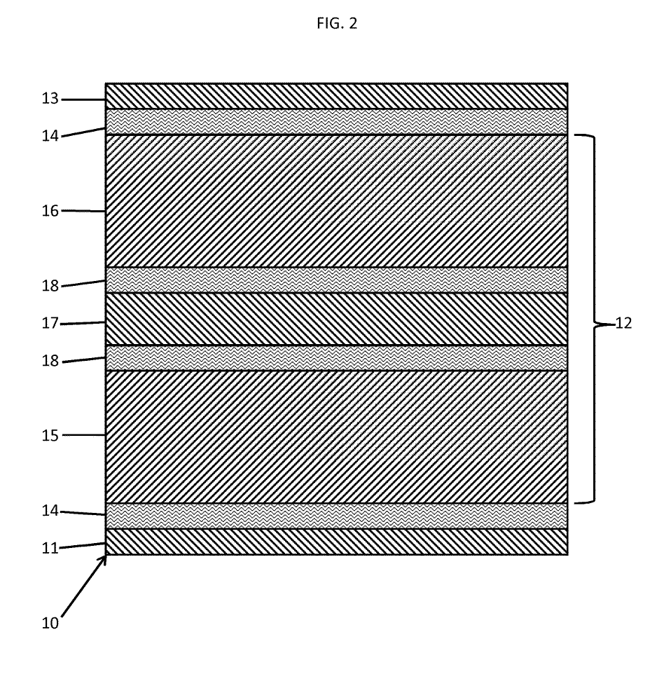

With reference now to FIG. 1A, a radome 10 is provided with an A-sandwich configuration. The radome 10 includes a first layer 11 of low density polymer (LDPE) through which electromagnetic radiation is transmittable, a second layer 12 of LDPE foam through which the electromagnetic radiation, having passed through the first layer, is transmittable, a third layer 13 of LDPE through which the electromagnetic radiation, having passed through the first and second layers, is transmittable and adhesive layers 14. The adhesive layers 14 are respectively interposed between the first layer 11 and the second layer 12 and between the second layer 12 and the third layer 13. For each of the first, second and third layers 11, 12 and 13, the LDPE and the LDPE foam may include at least one or more of polyethylene, polypropylene and polyolefin. For the adhesive layers 14, the adhesive used may include pressure sensitive adhesive (PSA).

With reference to FIG. 1B, the LDPE foam of the second layer 12 may be provided as a closed cell (i.e., moisture and corrosion resistant) foam 120 of substantially uniform or varying cell sizes. In either case, at an outer surface 121 of the second layer 12, the proximal cells of the closed cell foam 120 are open and include tangential corners 122. Thus, during formation of the radome 10, pressure applied to one or more of the first, second and third layers 11, 12 and 13 about the adhesive layers 14 causes a portion of the PSA to partially flow into the open proximal cells about the tangential corners 122. Once cured, this portion of the PSA increases an adherence of the first and second layers 11 and 12 and of the second and third layers 12 and 13.

In accordance with embodiments, respective thicknesses and colors of the first and third layers 11 and 13 may be off-the-shelf quantities and thus are relatively inexpensive. In accordance with further embodiments, the second layer 12 may be thicker, have a lower dielectric constant owing in part to the air in the cells and have a lower loss tangent than the first, third and adhesive layers 11, 13 and 14. In particular, the first and third layers 11 and 13 may be about 0.020″ thick, have dielectric constants, ∈, of about 2.3 and have loss tangents, tan δ, of about 0.0005, the second layer 12 may be about 0.525″ thick, have a dielectric constant, ∈, of about 1.15 and have a loss tangent, tan δ, of less than about 0.0001, and the adhesive layers 14 may be about 0.005″ thick, have dielectric constants, ∈, of about 3.0 and have loss tangents, tan δ, of about 0.017. Thus, the radome 10 of FIG. 1A may have a total thickness of about 0.575″, a max RF loss characteristic of about 0.15 dB for 0°-60° scan and a weight of about 0.52 lb/ft².

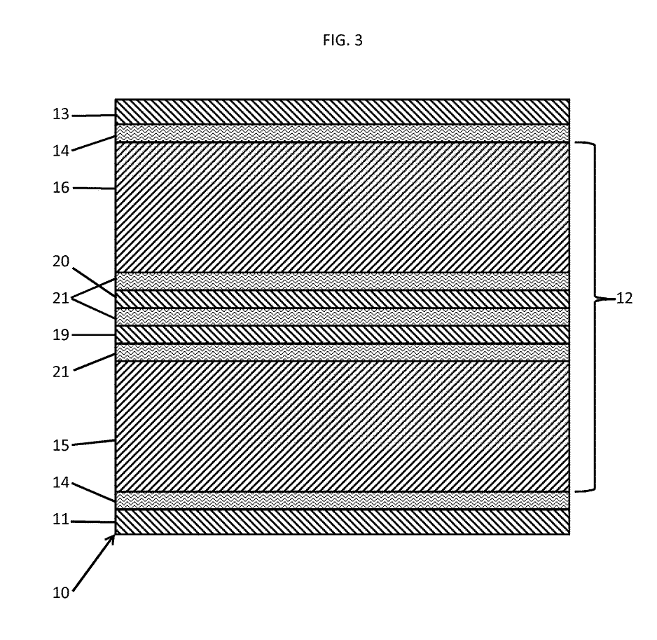

With reference to FIG. 2, the radome 10 may be provided with a first C-sandwich configuration in which the first, third and adhesive layers 11, 13 and 14 are provided generally as described above. The second layer 12 may include a primary LDPE foam layer 15, which is proximate to the first layer 11, a secondary LDPE foam layer 16, which is proximate to the third layer 13, a mid-layer LDPE layer 17, which is interposed between the primary and secondary LDPE foam layers 15 and 16 and additional adhesive layers 18. As shown in FIG. 2, the additional adhesive layers 18 are respectively interposed between the primary LDPE foam layer 15 and the mid-layer LDPE layer 17, and between the mid-layer LDPE layer 17 and the secondary LDPE foam layer 16.

As above (and for the embodiments of FIGS. 3-5), the LDPE and the LDPE foam may include at least one or more of polyethylene, polypropylene and polyolefin, the adhesive used may include pressure sensitive adhesive (PSA) and the primary and secondary LDPE foam layers 15 and 16 may be provided as closed cell (i.e., moisture and corrosion resistant) foams of substantially uniform or varying cell sizes. In any case, at outer surfaces of the LDPE foam layers, the proximal cells of the closed cell foams are open and include tangential corners. Thus, during formation of the radome 10 of FIG. 2 (and the radomes of FIGS. 3-5), applied pressure causes a portion of the PSA to partially flow into the open proximal cells about the tangential corners. Once cured, this portion of the PSA increases an adherence of the various layers.

In accordance with embodiments for the radome of FIG. 2, respective thicknesses and colors of the first and third layers 11 and 13 may be off-the-shelf quantities and thus are relatively inexpensive. In accordance with further embodiments, the second layer 12 may be thicker, have an effectively lower dielectric constant owing in part to the air in the cells and have an effectively lower loss tangent than the first, third and adhesive layers 11, 13 and 14. In particular, the first and third layers 11 and 13 may be about 0.023″ thick, have dielectric constants, ∈, of about 2.3 and have loss tangents, tan δ, of about 0.0005, the primary and second LDPE foam layers 15 and 16 may be about 0.385″ thick, have dielectric constants, ∈, of about 1.05 and have loss tangents, tan δ, of less than about 0.0001, the mid-layer LDPE layer 17 may be about 0.040″ thick, have a dielectric constant, ∈, of about 2.3 and have a loss tangent, tan δ, of about 0.0005 and the additional adhesive layers 18 may be about 0.005″ thick, have dielectric constants, ∈, of about 3.0 and have loss tangents, tan δ, of about 0.017. Thus, the radome 10 of FIG. 2 may have a total thickness of about 0.850″, a max RF loss characteristic of about 0.10 dB for 0°-60° scan and a weight of about 0.88 lb/ft².

With reference to FIG. 3, the radome 10 may be provided with a second C-sandwich configuration in which the first, third and adhesive layers 11, 13 and 14 are provided generally as described above. As for the second layer 12, the second layer 12 may include a primary LDPE foam layer 15, which is proximate to the first layer 11, a secondary LDPE foam layer 16, which is proximate to the third layer 13, and primary and second mid-layer LDPE layers 19 and 20. The primary mid-layer LDPE layer 19 is interposed between the primary and secondary LDPE foam layers 15 and 16 and is proximate to the primary LDPE foam layer 15. The secondary mid-layer LDPE layer 20 is interposed between the primary and secondary LDPE foam layers 15 and 16 and is proximate to the secondary LDPE foam layer 16. The radome 10 of FIG. 3 further includes additional adhesive layers 21. As shown in FIG. 3, these additional adhesive layers 21 are respectively interposed between the primary LDPE foam layer 15 and the primary mid-layer LDPE layer 19, between the primary and secondary mid-layer LDPE layers 19 and 20 and between the secondary mid-layer LDPE layer 20 and the secondary LDPE foam layer 16.

In accordance with embodiments for the radome of FIG. 3, respective thicknesses and colors of the first and third layers 11 and 13 may be off-the-shelf quantities and thus are relatively inexpensive. In accordance with further embodiments, the second layer 12 may be thicker, have an effectively lower dielectric constant owing in part to the air in the cells and have an effectively lower loss tangent than the first, third and adhesive layers 11, 13 and 14. In particular, the first and third layers 11 and 13 may be about 0.023″ thick, have dielectric constants, ∈, of about 2.3 and have loss tangents, tan δ, of about 0.0005, the primary and second LDPE foam layers 15 and 16 may be about 0.385″ thick, have dielectric constants, ∈, of about 1.05 and have loss tangents, tan δ, of less than about 0.0001, the primary mid-layer LDPE layer 19 may be about 0.023″ thick, have a dielectric constant, ∈, of about 2.3 and have a loss tangent, tan δ, of about 0.0005, the secondary mid-layer LDPE layer 20 may be about 0.023″ thick, have a dielectric constant, ∈, of about 2.3 and have a loss tangent, tan δ, of about 0.0005 and the additional adhesive layers 21 may be about 0.003″ thick, have dielectric constants, ∈, of about 3.0 and have loss tangents, tan δ, of about 0.017. Thus, the radome 10 of FIG. 3 may have a total thickness of about 0.867″, a max RF loss characteristic of about 0.12 dB for 0°-60° scan and a weight of about 0.93 lb/ft².

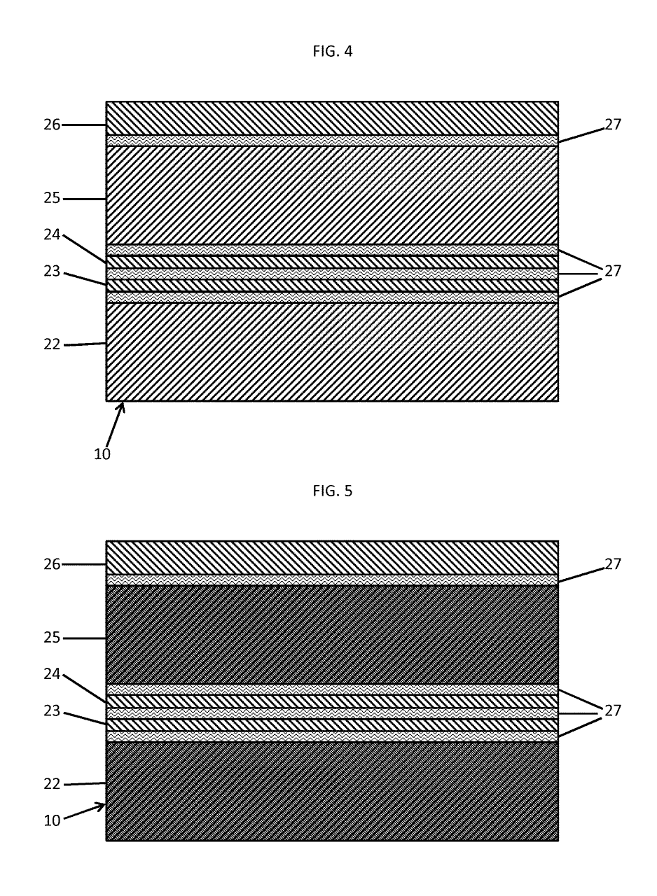

With reference to FIGS. 4 and 5, a radome 10 is provided with multi-layer (ML) configurations. The radome 10 includes a first layer 22 of LDPE foam through which electromagnetic radiation is transmittable, a second layer 23 of LDPE through which the electromagnetic radiation, having passed through the first layer 22, is transmittable, a third layer 24 of LDPE through which the electromagnetic radiation, having passed through the first and second layers 22 and 23, is transmittable, a fourth layer 25 of LDPE foam through which the electromagnetic radiation, having passed through the first, second and third layers 22, 23 and 24, is transmittable and a fifth layer 26 of LDPE through which the electromagnetic radiation, having passed through the first, second, third and fourth layers 22, 23, 24 and 25, is transmittable. In addition, the radome 10 of FIGS. 4 and 5 may include adhesive layers 27 that are respectively interleaved between the first, second, third, fourth and fifth layers 22, 23, 24, 25 and 26.

For each of the first-fifth layers 22-26, the LDPE and the LDPE foam may include at least one or more of polyethylene, polypropylene and polyolefin. For the adhesive layers 27, the adhesive used may include pressure sensitive adhesive (PSA). While the LDPE foam described with reference to FIGS. 1-4 may be provided as 10% LDPE foam, the LDPE foam of FIG. 5 may be provided as black LDPE foam.

In accordance with embodiments for the radome of FIG. 4, respective thicknesses and colors of the first-fifth layers 22-26 may be off-the-shelf quantities and thus are relatively inexpensive. In accordance with further embodiments, the first and fourth layers 22 and 25 may be thicker, have a lower dielectric constant owing in part to the air in the cells and have a lower loss tangent than the second, third, fifth and adhesive layers 23, 24, 26 and 27. In particular, the first and fourth layers 22 and 25 may be about 0.415″ and 0.315″ thick, respectively, have dielectric constants, ∈, of about 1.05 and have loss tangents, tan δ, of less than about 0.0001, the second and third layers 23 and 24 may be about 0.023″ thick, have dielectric constants, ∈, of about 2.3 and have loss tangents, tan δ, of less about 0.0005, the fifth layer 26 may be about 0.060″ thick, have a dielectric constant, ∈, of about 2.3 and have a loss tangent, tan δ, of about 0.0005 and the adhesive layers 27 may be about 0.003″ thick, have dielectric constants, ∈, of about 3.0 and have loss tangents, tan δ, of about 0.017. Thus, the radome 10 of FIG. 4 may have a total thickness of about 0.848″, a max RF loss characteristic of about 0.25 dB for 0°-60° scan and a weight of about 0.96 lb/ft².

In accordance with embodiments for the radome of FIG. 5, respective thicknesses and colors of the first-fifth layers 22-26 may be off-the-shelf quantities and thus are relatively inexpensive. In accordance with further embodiments, the first and fourth layers 22 and 25 may be thicker, have a lower dielectric constant owing in part to the air in the cells and have a lower loss tangent than the second, third, fifth and adhesive layers 23, 24, 26 and 27. In particular, the first and fourth layers 22 and 25 may be about 0.410″ and 0.310″ thick, respectively, have dielectric constants, ∈, of about 1.066 and have loss tangents, tan δ, of less than about 0.001, the second and third layers 23 and 24 may be about 0.023″ thick, have dielectric constants, ∈, of about 2.3 and have loss tangents, tan δ, of less about 0.0005, the fifth layer 26 may be about 0.060″ thick, have a dielectric constant, ∈, of about 2.3 and have a loss tangent, tan δ, of about 0.0005 and the adhesive layers 27 may be about 0.003″ thick, have dielectric constants, ∈, of about 3.0 and have loss tangents, tan δ, of about 0.017. Thus, the radome 10 of FIG. 5 may have a total thickness of about 0.838″, a max RF loss characteristic of about 0.25 dB for 0°-60° scan and a weight of about 0.95 lb/ft².

For each of the embodiments described above, the LPDE on the exteriors of the radomes 10 act as skins for providing the radomes 10 with ruggedness and toughness even while being possibly deformable and compliant. Similarly, the LDPE in the interiors of the radomes 10 also provide the radomes 10 with increased ruggedness and toughness without sacrificing deformability and compliance. Meanwhile, the LDPE foam may be provided as compliant or deformable layer(s). In any case, while radomes in general are formed as rigid or semi-rigid structures, the radomes 10 described above may be characteristically deformable and compliant in at least some layers thereof. As such, impacts with foreign debris in particular can be absorbed and/or deflected. Thus, where foreign debris impacts might be catastrophic to a conventional radome, such incidents may not even lead to damage to the radomes 10 described above.

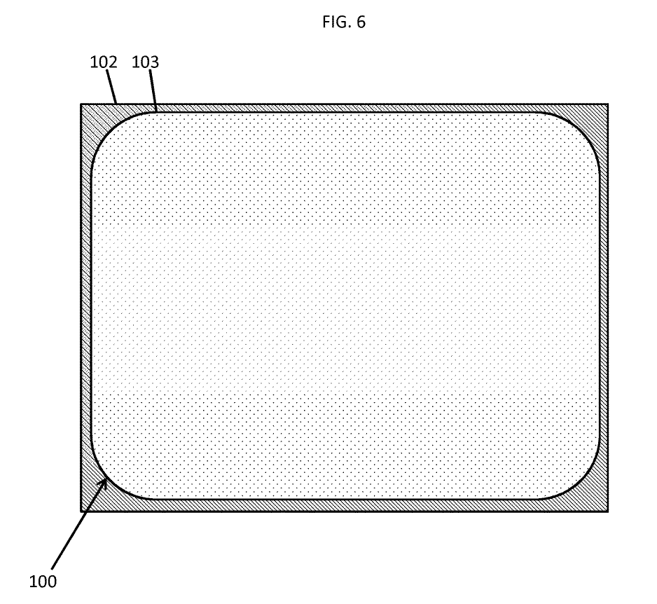

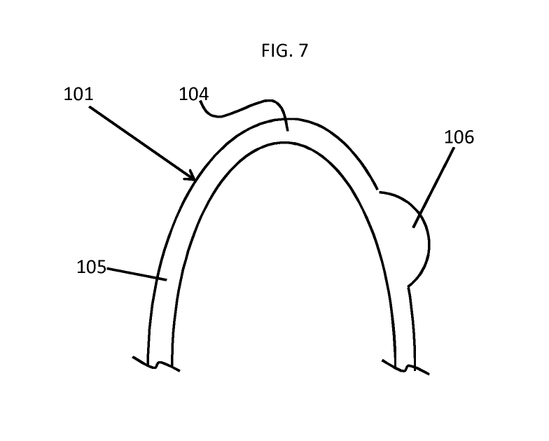

With reference to FIGS. 6 and 7, the radomes 10 described above may be provided as planar radomes 100 (see FIG. 6) or as curved or complex-shaped radomes 101 (see FIG. 7).

In the former case, the planar radomes 100 may be housed in a housing 102 that is formed to define an aperture 103 through which electromagnetic radiation or any other signals are transmittable. In this case, the corresponding planar radome 100 is configured to extend entirely across the aperture 103 such that the electromagnetic radiation/other signals pass through the planar radome 103 during the transmittance.

In the latter case, the curved or complex-shaped radomes 101 may be configured for use in, for example, a nose cone of a missile or aircraft. As such, the curved or complex-shaped radomes 101 may include an aerodynamic nose cone section 104, sidewalls 105 extending aft from the nose cone section 104 and one or more surface features 106 for housing or accommodating structural elements, sensors, etc. In such cases, the nose cone section 104 may be more apt to experience foreign debris impacts than the sidewalls 105 and the sidewalls 105 may need to be more transparent to electromagnetic radiation/signals. Thus, the curved or complex-shaped radomes 101 can be designed such that the nose cone section 104 is more rugged than the sidewalls 105 and such that the sidewalls 105 are more transparent and less prone to signal loss than the nose cone section 104.

To this end, any one of the LDPE or LDPE foam layers described above may be provided with varied intra-layer characteristics. For example, in a case where the radome 10 of FIG. 1A is used as a curved or complex-shaped radome 101, the LDPE foam of the second layer 12 may be provided with varying cell sizes in the nose cone section 104 and the sidewalls 105. More particularly, the cell sizes in the nose cone section 104 may be relatively small as compared to the cell sizes in the sidewalls 105 to provide the nose cone section 104 with increased ruggedness while maintaining low loss characteristics of the sidewalls 105.

In accordance with additional aspects, it is to be understood that the various layers of LDPE and LDPE foam described above may be formed by way of rotational molding and/or other similar methods, such as injection molding, rotational casting, casting, machining and three-dimensional printing.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A radome, comprising:
a first layer of low density polymer (LDPE) through which electromagnetic radiation is transmittable;
a second layer of LDPE foam through which the electromagnetic radiation, having passed through the first layer, is transmittable;
a third layer of LDPE through which the electromagnetic radiation, having passed through the first and second layers, is transmittable; and
adhesive layers respectively interposed between the first and second layers and between the second and third layers.

2. The radome according to claim 1, wherein the LDPE and the LDPE foam comprise at least one or more of polyethylene, polypropylene and polyolefin and the adhesive layers comprise pressure sensitive adhesive (PSA).

3. The radome according to claim 1, wherein the LDPE foam is compliant.

4. The radome according to claim 1, wherein the second layer is thicker, has a lower dielectric constant and has a lower loss tangent than the first, third and adhesive layers.

5. The radome according to claim 1, wherein the first and third layers are about 0.020″ thick and the second layer is about 0.005″ thick.

6. The radome according to claim 1, wherein the second layer comprises:
primary and secondary LDPE foam layers;
a mid-layer LDPE layer interposed between the primary and secondary LDPE foam layers; and
adhesive layers respectively interposed between the primary LDPE foam layer and the mid-layer LDPE layer and between the mid-layer LDPE layer and the secondary LDPE foam layer.

7. The radome according to claim 6, wherein the first and third layers are about 0.020″ thick, the primary and secondary LDPE foam layers are about 0.375″ thick and the mid-layer LDPE layer is about 0.040″ thick.

8. The radome according to claim 1, wherein the second layer comprises:
primary and secondary LDPE foam layers;
primary and secondary mid-layer LDPE layers interposed between the primary and secondary LDPE foam layers; and
adhesive layers respectively interposed between the primary LDPE foam layer and the primary mid-layer LDPE layer, between the primary and secondary mid-layer LDPE layers and between the secondary mid-layer LDPE layer and the secondary LDPE foam layer.

9. The radome according to claim 8, wherein the first and third layers are about 0.023″ thick, the primary and secondary LDPE foam layers are about 0.385″ thick and the primary and secondary mid-layer LDPE layers are about 0.023″ thick.

10. A radome, comprising:
a first layer of low density polymer (LDPE) foam through which electromagnetic radiation is transmittable;
a second layer of LDPE through which the electromagnetic radiation, having passed through the first layer, is transmittable;
a third layer of LDPE through which the electromagnetic radiation, having passed through the first and second layers, is transmittable;
a fourth layer of LDPE foam through which the electromagnetic radiation, having passed through the first, second and third layers, is transmittable;
a fifth layer of LDPE through which the electromagnetic radiation, having passed through the first, second, third and fourth layers, is transmittable; and
adhesive layers respectively interleaved between the first, second, third, fourth and fifth layers.

11. The radome according to claim 7, wherein the LDPE and the LDPE foam comprise at least one or more of polyethylene, polypropylene and polyolefin and the adhesive layers comprise pressure sensitive adhesive (PSA).

12. The radome according to claim 7, wherein the LDPE foam comprises black LDPE foam.

13. The radome according to claim 7, wherein the LDPE foam is compliant.

14. The radome according to claim 7, wherein the first and fourth layers are thicker, have a lower dielectric constant and have a lower loss tangent than the second, third, fifth and adhesive layers.

15. The radome according to claim 8, wherein the first and fourth layers are about 0.410″ and 0.310″ thick, respectively, the second and third layers are about 0.023″ thick and the fifth layer is about 0.060″ thick.

16. A method of forming a radome, the method comprising:
rotomolding two or more layers of low density polymer (LDPE);
rotomolding one or more layers of LDPE foam; and
adhering the two or more layers of LDPE and the one or more layers of LDPE foam.

17. The method according to claim 16, wherein the LDPE and the LDPE foam comprise at least one or more of polyethylene, polypropylene and polyolefin.

18. The method according to claim 16, wherein the LDPE foam is compliant.

19. The method according to claim 16, wherein the two or more layers of LDPE and the one or more layers of LDPE foam are planar or curved.

20. The method according to claim 16, wherein at least one of the two or more layers of LDPE and the one or more layers of LDPE foam have a complex shape.
